(19) United States
(12) Patent Application Publication
(10) Pub. No.: US 2015/0019621 A1
(43) Pub. Date: Jan. 15, 2015

(54) Cross-Platform System for Remote-Controlling Network Camera

(71) Applicant: AFREEY INC., New Taipei City (TW)

(72) Inventor: Shao-Wen Kao, Taipei City (TW)

(21) Appl. No.: 13/938,320

(22) Filed: Jul. 10, 2013

(51) Int. Cl. H04L 29/08

(52) U.S. Cl. CPC H04L 67/10
USPC 709/203

(57) ABSTRACT

This invention discloses a cross-platform system for remote-controlling Network camera. The cross-platform system for remote-controlling Network camera comprises a Network camera, a server electronic coupled with the Network camera, and a device with at least one browser. The device can link to the server for requesting information from the Network camera through different browsers by one check object. The check object will identify the type of the browser, and help browser(s) interacting with the server/Network camera. Preferably, the check object is suitable for different browser, different operation system, and more than one Network camera. More preferably, the cross-platform system for remote-controlling Network camera also can be used on portable device.

### BACKGROUND OF THE INVENTION

1. Field of the Invention

The present invention is generally related to a system for remote surveillance Network camera, and more particularly to a cross-platform system for remote surveillance and remote-controlling Network camera.

2. Description of the Prior Art

In recent years, surveillance system is more and more popular. By using surveillance camera, people can save manpower on watching, and can easily monitor several places on surveillance screen at the same time. With the development of Internet, the information taken by Network camera(s) (IP camera) can be read through Internet. For example, it is possible that a user can use a computer at home to link a Network camera at a distance from home for monitoring a factory.

Generally, people use browser to watch the information taken by Network camera. The present browser can be simply classified as IE (Internet Explorer) and non-IE (non-Internet Explorer). When linking to a Network camera, IE and non-IE browsers have to respectively call different interface firstly, so that the web-page of the browser can full display the information from the Network camera. In order to serve different browsers in users' device, the Network camera producers have to provide different plug-ins for each type of Network camera, and maintain them. That is a huge burden for those producers. Besides, a Network camera user may have several browsers in a device. The Network camera user may have to either install several plug-ins for those browsers in the device, or switch around the user's preferred browser and the browser for Network camera. Both of the mentioned options are not friendly to an end user.

In view of the above matter, developing a novel cross-platform system for remote surveillance and remote controlling Network camera having the adventures of simplifying producer's work and being friendly to end user is still an important task for the industry.

### SUMMARY OF THE INVENTION

In light of the above background, in order to fulfill the requirements of the industry, the present invention provides a novel cross-platform system for remote surveillance and remote controlling Network camera having the adventures of simplifying producer's work and being friendly to end user, so that the competitive ability of the Network camera with the above-mentioned cross-platform system can be improved.

One object of the present invention is to provide a cross-platform system for remote surveillance and remote controlling Network camera to simplify the Network camera producer's work by providing only one plug-in suitable to both IE and non-IE browser.

Another object of the present invention is to provide a cross-platform system for remote surveillance and remote controlling Network camera to be friendly to Network camera end user by only one time installation being able to suitable for all those browsers, including IE and non-IE browser, in the device to link Network camera.

Accordingly, the present invention discloses a cross-platform system for remote-controlling Network camera. The mentioned cross-platform system for remote-controlling Network camera comprises a Network camera, a server electronic coupled with the Network camera, and a device with at least one browser. When one browser in the device firstly linking to the server for requesting the information from Network camera, in order to decode all the information from the server, a check object will be installed into the device. The check object will check the type of the browser and tell the browser to call suitable interface/Plug-in(s) in the device, if necessary, to support the browser to display the information from the Network camera. Excluding the update request, the device can use both IE and non-IE browsers to display the information and remote-controlling the Network camera without further installation. Therefore, according to this invention, the cross-platform system for remote-controlling Network camera can efficiently reduce Network camera producer's burden, and be friendlier to Network camera end user.

### BRIEF DESCRIPTION OF THE DRAWINGS

The present disclosure can be described by the embodiments given below. It is understood, however, that the embodiments below are not necessarily limitations to the present disclosure, but are used to a typical implementation of the invention.

FIG. 1 shows a cross-platform system for remote-controlling Network camera according to this invention; and

FIG. 2 shows a flow chart of a cross-platform system for remote-controlling Network camera according to this invention.

### DESCRIPTION OF THE PREFERRED EMBODIMENTS

What probed into the invention is a cross-platform system for remote-controlling Network camera. Detailed descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater details in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

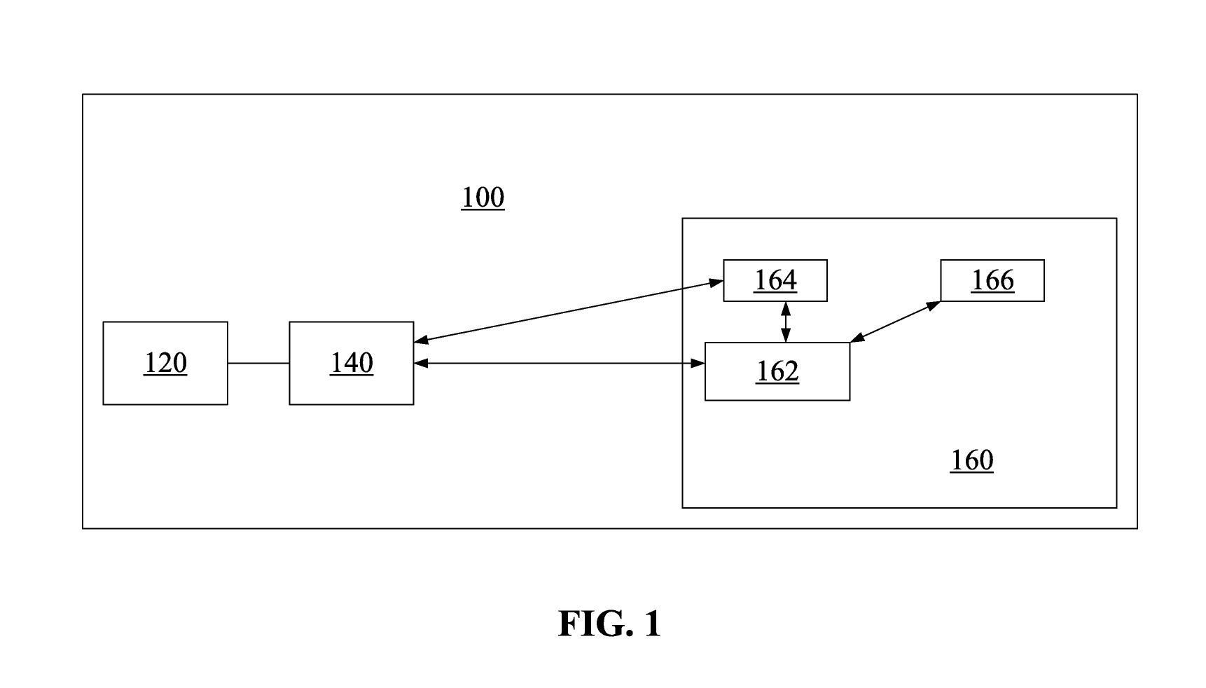

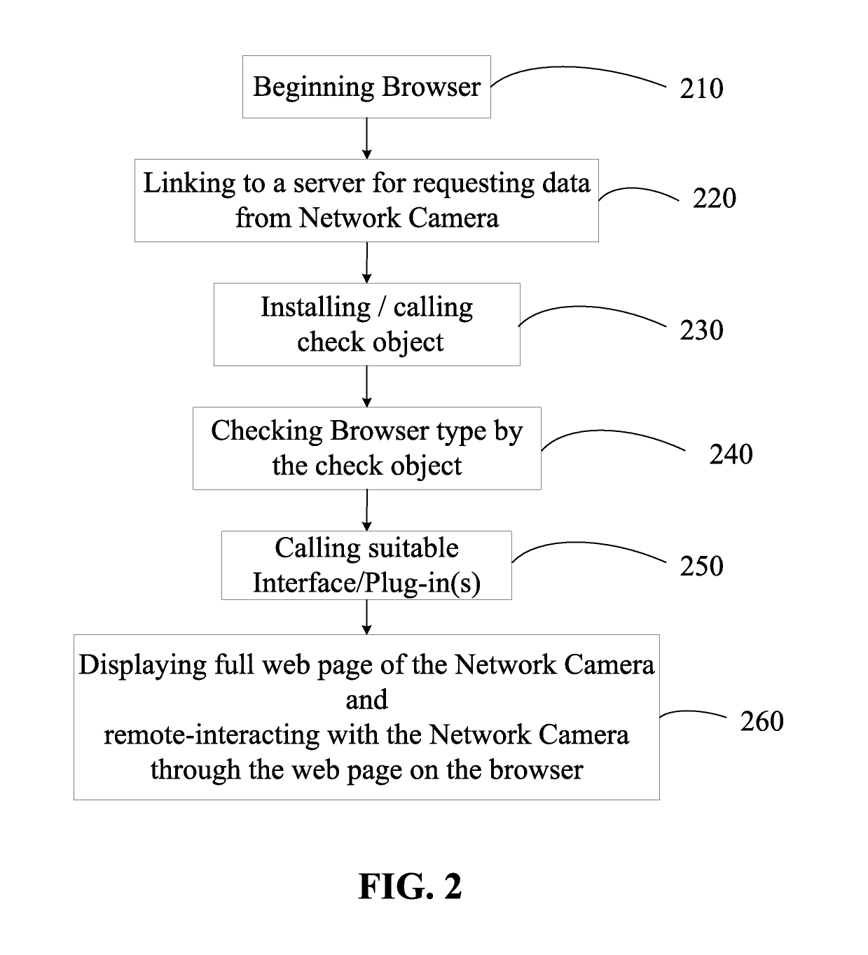

One preferred embodiment according to this specification discloses a cross-platform system for remote-controlling Network camera. FIG. 1 shows a cross-platform system for remote-controlling Network camera of this embodiment. FIG. 2 shows a flow chart of a cross-platform system for remote-controlling Network camera according to this embodiment. Referred to FIG. 1, the cross-platform system for remote-controlling Network camera 100 comprises a Network camera 120, a server 140, and a device 160. The device 160 is selected from a desktop computer, a work station, or a portable device, wherein the portable device can be a laptop computer, a PDA, a hand-held computer, a smart phone, a tablet computer, or other device with at last one browser. The server 140 is electric coupled with the Network camera 120. When the device 160 is employed to take information from the Network camera 120, a browser 162 is begun, as the step 210, and the browser 162 is going to link to the server 140, as the step 220. If it is the first time that the device 160 links to the server 140, the device 160 is going to download and install a check object 164 from the server 140. Otherwise, the check object 164 will be called directly, as shown in the step 230 in FIG. 2. The check object 164 will check the type of the browser 162, as the step 240, and tell the browser 162 to call suitable interface/Plug-in(s) 166 in the device 160 according to the type of the browser 162, as shown in the step 250. With the supporting of the called interface/Plug-in(s) 166, all the information from the Network camera 120 can be displayed on the browser 162 with full web page, as shown in the step 260. In one preferred example of this embodiment, the browser 162 not only can display the information from the Network camera 120, but also can remote-interact with the Network camera 120.

In one preferred example of this embodiment, the server 140 is linked with the device 160 through wire network. In another preferred example of this embodiment, the server 140 is connected with the device 160 through wireless network.

According to this embodiment, the device 160 only has to download and install the check object 164 once, even the device 160 is going to use different browser for interacting with the Network camera 120. The installed check object 164 will be recalled when the browser 162 is communicating with the server 140 and decoding the information from the server 140. When the check object 164 is recalled, the check object 164 will check the type of the browser 162, and telling the browser 162 to call suitable interface/Plug-in(s) 166 based on the processing browser 162 dialoging with the server 140, so that all the information from the server 140 can be displayed on the browser 162 with the assistance of the called interface/Plug-in(s) 166. Moreover, with the assistance of the called interface/Plug-in(s) 166, the browser 162 can further remote-control the Network camera 120, if necessary. In one preferred example of this embodiment, excluding checking the browser type, the check object 164 can comprise a number of interface/Plug-in(s) to help the browser 162 to decode and display the information from the server 140.

In one preferred example of this embodiment, the browser 162 is IE (Internet Explorer). When IE sends a request to the server 140 for connecting the Network camera 120, in order to decode all the information from the server 140, the browser 162 will check whether the device 160 has installed the check object 164. If the device 160 does not have installed the check object 164 before, the device 160 will download and install the check object 164 from the server 140. If the check object 164 has been installed in the device 160, the check object 164 will try to find out what type of the browser 162 is dialoging with the server 140. In this example, the check object 164 will find out that it is IE dialoging with the server 140. So that the check object 164 is going to tell the browser 162, the IE, to call Active X control from the device 160 as the suitable interface/Plug-in(s) 166 for supporting the IE browser 162. Subsequently, the called interface 166, Active X control, is going to support the browser 162 for displaying full web page of all the information from the Network camera 120 and remote-interacting with the Network camera 120 through the web page.

In another preferred example of this embodiment, the browser 162 is non-IE, such as Firefox, Chrome, Safari, Opera, etc. According to this example, when the non-IE browser 162 sends a request to the server 140 for connecting the Network camera 120, in order to decode all the information from the server 140, the browser 162 will check whether the device 160 has installed the check object 164. If the device 160 does not have installed the check object 164 before, the device 160 will download and install the check object 164 from the server 140. If the check object 164 has been installed in the device 160, the check object 164 will try to identify what type of the browser 162 is dialoging with the server 140. In this example, the check object 164 will find out that it is non-IE browser dialoging with the server 140, and the check object 164 is going to tell the non-IE browser to call NPAPI (Netscape Interface Application Program Interface), for example, as the suitable Interface/Plug-in(s) 166 for supporting the non-IE browser 162 decoding and displaying full web page of the information from the Network camera 120 on the non-IE browser 162. Moreover, the called interface/Plug-in(s) 166 may also support the device 160 to remote-interact with the Network camera 120 through the web page on the browser 162.

The mentioned “displaying” comprises display the video and the audio information from the Network camera. The mentioned remote-interacting with Network camera comprises controlling the video/audio signal of the Network camera, controlling the video zoom in/zoom out, controlling the lens movement of the Network camera while the Network camera using PTZ lens (Pan Tilt Zoom lens), performing two-way audio displaying while the Network camera having a speaker, performing full-screen displaying on the device, pan/tilt the camera, volume control, digital magnifying/minifying, taking picture, video recording, and so on.

According to this invention, an user can easily monitoring on and remote-interacting with Network camera(s) on different browsers in one device. When a device without the check object of this invention links to the server of the Network camera, the device will download and install the check object firstly. After installing the check object, the device not only can link to the server of the Network camera through different browsers, but also can decode all the information from the server and display those information on the browser dialoging with the server. Preferably, the check object of this invention is suitable for different operation system, such as Windows, Mac, and Linux, etc. More preferably, the mentioned cross-platform system for remote-controlling Network camera is also suitable for a portable device, such as a PDA, a smart phone or a tablet computer. Recently, the browser on a portable device cannot be full supported for displaying the video/audio signal from Network camera, because the browser on a portable device does not be supported by plug-in. However, for portable device, the mentioned installed check object of this invention can further comprise a number of dynamic web-page programs, wherein the mentioned dynamic web-page program is selected from at least one of the following: html5, css3, javascript, html, css, and other program for dynamic web-page known by the one skilled in the art, to support the browser for displaying video/audio signal from Network camera, and/or achieving other plug-in performance on the browser. The check object can tell the browser of the portable device to call the dynamic web-page for supporting on decoding and displaying the information from the server on any browser on any operation system in a portable device. Therefore, for an end user of Network camera, no matter what kind of operation system the device is and no matter what kind of browser(s) the device is/are operating, one time installation of the check object can full allow the device to link to the Network camera, and decode all information from the Network camera and monitoring/remote-controlling the Network camera. More preferably, for the Network camera producer, it is not necessary to provide different software for different browser any more. So that, the cross-platform system for remote-controlling Network camera of this invention is more conveniently and economically for both user and producer of Network camera.

In summary, we have reported a cross-platform system for remote-controlling Network camera. The mentioned cross-platform system for remote-controlling Network camera comprises a Network camera, a server, and a device with browser. When the browser of the device linking to the server for requesting information of the Network camera, the device is going to download and install a check object. Once the check object installed, all the information from the server/Network camera can be decode and display on the browser dialoging with the server, and the device can interact with the Network camera through different browser. In order to supporting the browser displaying the information from the Network camera and remote-interacting with the Network camera, the check object is going to identify the type of the browser dialoging with the server, and tell the browser to call suitable interface/Plug-in(s)/dynamic web-page program based on the type of the browser. Furthermore, the check object of this invention can also comprise interface/Plug-in(s)/dynamic web-page program for help the browser to decode and display the information from the server, and remote-interact with Network camera through the browser web page. According to this invention, a user does not have to install several software for different browsers in one device for monitoring/remote-interacting with one and/or a number of Network camera(s). And, a Network camera user also does not have to switch around different browsers for monitoring Network camera—if there is no suitable plug-ins for the user's favorite browser. So that, the cross-platform system for remote-controlling Network camera of this invention is more convenient for Network camera user. For the Network camera producer, according to this invention, one software, as the mentioned check object, can satisfy different browsers, and different device, so that the Network camera producer does not have to prepare different software for different browsers. More preferably, the check object can be suitable for more than one Network camera. Therefore, the mentioned cross-platform system for remote-controlling Network camera is also convenient and economical to Network camera producer. More preferably, the cross-platform system for remote-controlling Network camera is not only suitable for desktop device, but also suitable for portable device. As portable device is more and more general for people, the cross-platform system for remote-controlling Network camera is more and more important for the competitive ability in Network camera industry.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A cross-platform system for remote-controlling Network camera comprising:
a Network camera;
a server coupled with the Network camera; and
a device with at least one browser, wherein the device links to the server through one of said browsers and installs a check object from the server if the device does not install said check object before, wherein the check object is called to identify the type of the browser dialoging with the server and tell the browser to call an interface/Plug-in(s)/dynamic web-page program(s) from the device according to the type of the browser, wherein said interface/Plug-in(s)/dynamic web-page program(s) supports the browser to display information from the Network camera and supports the device to remote-interact with the Network camera through a web page of the browser.

2. The cross-platform system for remote-controlling Network camera according to claim 1, wherein said check object comprises interface/Plug-in(s).

3. The cross-platform system for remote-controlling Network camera according to claim 1, wherein said check object comprises dynamic web-page program(s).

4. The cross-platform system for remote-controlling Network camera according to claim 1, wherein the browser is selected from one of the following: Internet Explorer, Chrome, Safari, Firefox, and Opera.

5. The cross-platform system for remote-controlling Network camera according to claim 1, wherein said browser is Internet Explorer (IE), and said interface/Plug-in(s)/dynamic web-page program(s) is with ActiveX control.

6. The cross-platform system for remote-controlling Network camera according to claim 1, wherein said browser is non-IE, and said interface/Plug-in(s)/dynamic web-page program(s) is with NPAPI (Netscape Interface Application Program Interface).

7. The cross-platform system for remote-controlling Network camera according to claim 1, wherein said interface/Plug-in(s) is selected from one of the following: Quick Time plug-in, Flash player plug-in, Java, Mjpeg.

8. The cross-platform system for remote-controlling Network camera according to claim 1, wherein said device with at least one browser is selected from one of the following: a work station, a desktop device, and a portable device.

9. The cross-platform system for remote-controlling Network camera according to claim 1, wherein said device with at least one browser is selected from one of the following: a laptop computer, a PDA, a hand-held computer, a smart phone, and a tablet computer.

10. The cross-platform system for remote-controlling Network camera according to claim 1, wherein said device is a portable device, and said interface/Plug-in(s)/dynamic web-page program(s) is selected from at least one of the following: html5, css3, html, css, and javascript.

11. The cross-platform system for remote-controlling Network camera according to claim 1, wherein said interface/Plug-in(s)/dynamic web-page program(s) is called from the installed check object in the device.
